(19) United States
(12) Patent Application Publication
(10) Pub. No.: US 2026/0200683 A1
(43) Pub. Date: Jul. 16, 2026

(54) CARRIER SYSTEM FOR GOODS TO BE CONVEYED FOR MOVEMENT ON A CONVEYING SURF ACE OF A PLANAR MOTOR DRIVE SYSTEM

(71) Applicant: Provisur Technologies, Inc., Chicago, IL (US)

(72) Inventors: Jurgen BIALY, Oeschebuttel (DE); Klaus-Dieter SCHROFF, Konstanz (DE)

(73) Assignee: Provisur Technologies, Inc., Suite 720, IL (US)

(21) Appl. No.: 19/136,744

(22) PCT Filed: Dec. 18, 2023
(86) PCT No.: PCT/EP2023/086428

§ 371 Date: Jun. 6, 2025

(30) Foreign Application Priority Data
Mar. 29, 2023 (DE) 10 2023 107 981.6

(51) Int. Cl. B65G 45/18; B65G 45/14; B65G 54/02

(52) U.S. Cl. CPC B65G 45/18; B65G 45/14; B65G 54/02; B65G 2201/0202; B65G 2201/0258; B65G 2207/26

(57) ABSTRACT

A carrier system for goods to be transported for movement on a conveying surface of a planar motor drive system is provided. The system has a carrier with a loading surface for receiving goods to be conveyed, a cleaning device for cleaning the conveying surface, and a mechanical coupling between the carrier and the cleaning device in the horizontal direction, so that the carrier entrains the cleaning device during a horizontal movement along the conveying surface. The mechanical coupling in the vertical direction at right angles to the conveying surface permits a range of movement between the carrier and the cleaning device or a free vertical relative movement of the carrier relative to the cleaning device.

### TECHNICAL FIELD OF THE INVENTION

The invention relates to a carrier system for goods to be transported for transporting the goods to be transported (e.g. food products) on a horizontal conveying surface of a planar motor drive system.

Furthermore, the invention relates to a planar motor drive system with at least one such carrier system for goods to be transported and a food processing line with such a carrier system for goods to be transported or with such a planar motor drive system.

Finally, the invention also relates to the use of such a carrier system for goods to be transported or such a planar motor drive system in a food processing line.

### BACKGROUND TO THE INVENTION

It is known from the state of the art (e.g. DE 10 2021 105 103 A1) to transport food products (e.g. stacks of sausage slices or cheese slices) in a food processing line on carriers for the goods to be transported, whereby the carriers for the goods to be transported are also referred to as “movers” or “shuttles” and are moved by a planar motor drive system on a horizontal conveying surface along a freely programmable conveyor path.

Furthermore, it is known from the prior art (see DE 10 2021 105 103 A1) to attach a cleaning device to the individual carrier for the goods to be transported, which can consist of a cleaning brush or a scraper, for example, and has the task of keeping the conveying surface on the conveying path free of dirt (e.g. product residues). This is intended to prevent dirt from penetrating into the gap between the conveying surface of the planar motor drive system and the carrier for the goods to be transported, which would cause the carrier for the goods to be transported to leave its predetermined levitation height.

A disadvantage of this known carrier system for goods to be transported with a cleaning device (e.g. cleaning brush) attached to the carrier for the goods to be transported is the fact that the maximum load capacity of the carrier for the goods to be transported is reduced by the mass of the cleaning device, as the planar motor drive system must hold both the actual carrier for the goods to be transported and the cleaning device attached to it at the levitation height.

In the state of the art, the cleaning device must therefore be as light as possible, which in turn entails the risk of the cleaning device being lifted off by dirt particles on the conveying surface and not having a satisfactory cleaning effect.

With regard to the general technical background of the invention, reference should also be made to patent publications KR 10 2013 000 763 A and CN 107 802 214 A, which, however, belong to completely different technical fields and have no relation to the relevant technical field of food processing machines.

### DESCRIPTION OF THE INVENTION

The invention is therefore based on the task of creating a correspondingly improved carrier system for goods to be transported.

This task is solved by a carrier system for the goods to be transported according to the invention as described in the main claim.

In accordance with the state of the art described at the beginning, the carrier system for the goods to be transported according to the invention initially comprises a carrier for the goods to be transported, which can also be referred to as a “mover” or “shuttle” in accordance with the usual technical terminology. On its upper side, the carrier for the goods to be transported has a loading surface which serves to receive goods to be transported, such as food products (e.g. stacks of slices of sausage or cheese).

Furthermore, in accordance with the state of the art described at the beginning, the carrier system for the goods to be transported according to the invention also comprises a cleaning device in order to clean the conveying surface of the planar motor drive system.

In this case, the cleaning device is connected to the actual carrier for the goods to be transported via a mechanical coupling, with the mechanical coupling acting in a horizontal direction in accordance with the prior art described above, so that the carrier for the goods to be transported moves the cleaning device during a horizontal movement along the conveying surface. The mechanical coupling between the carrier for the goods to be transported and the cleaning device therefore acts in a horizontal direction and ensures that the carrier for the goods to be transported and the cleaning device move synchronously on the conveying surface, i.e. in the same direction and at the same speed.

The invention now differs from the prior art described at the beginning in that the mechanical coupling between the carrier for the goods to be transported and the cleaning device allows a range of movement between the carrier for the goods to be transported and the cleaning device in the vertical direction (i.e. at right angles to the conveying surface of the planar motor drive system) or even allows a free vertical relative movement of the carrier for the goods to be transported relative to the cleaning device. In the carrier system for the goods to be transported according to the invention, the actual carrier for the goods to be transported can therefore move freely in the vertical direction (i.e. at right angles to the conveying surface of the planar motor drive system) at least within the range of movement relative to the cleaning device.

This is advantageous because it means that the maximum load-bearing capacity of the carrier for the goods to be transported is not limited by the weight of the cleaning device. During operation, the cleaning device therefore preferably rests on the conveying surface of the planar motor drive system, so that the cleaning device is supported and carried by the conveying surface of the planar motor drive system, while the carrier for the goods to be transported is held at the required levitation height by the planar motor drive system. In the planar motor drive system according to the invention, the planar motor drive system therefore preferably only has to support the carrier for the goods to be transported, but not the cleaning device. This also makes it possible to design the cleaning device to be relatively heavy, which largely prevents the cleaning device from lifting off the conveying surface, as will be explained in more detail.

In a preferred embodiment of the invention, the cleaning device has a frame that surrounds the actual carrier for the goods to be transported in the shape of a frame. This ensures that the carrier for the goods to be transported carries the cleaning device along the conveying path during movement on the conveying surface.

In this case, the frame of the cleaning device has an inner contour, while the carrier for the goods to be transported has a correspondingly complementary outer contour. In the preferred embodiment of the invention, the inner contour of the cleaning device and the outer contour of the carrier for the goods to be transported are each rectangular. The inner contour of the frame of the cleaning device preferably has an oversize compared to the outer contour of the carrier for the goods to be transported, so that there is a gap between the outer contour of the carrier for the goods to be transported and the inner contour of the frame of the cleaning device, which allows the vertical relative movement of the carrier for the goods to be transported relative to the cleaning device. The frame of the cleaning device therefore loosely embraces the carrier of the goods to be transported in order to allow the vertical movement space between the carrier of the goods to be transported and the frame of the cleaning device.

It should also be mentioned that the frame of the cleaning device and the carrier for the goods to be transported are both preferably partially made of metal (e.g. steel, stainless steel). This is worth mentioning because contact between the metal carrier for the goods to be transported on the one hand and the metal frame of the cleaning device on the other should be avoided during operation. A spacer made of plastic (e.g. rubber) is therefore preferably arranged between the frame of the cleaning device and the carrier for the goods to be transported, which prevents direct contact between the metal frame of the cleaning device and the metal conveyor carrier. This spacer is preferably detachably attached to the frame of the cleaning device.

In the preferred embodiment of the invention, the frame of the cleaning device has projections on its upper side which project inwardly beyond the inner contour of the frame and limit the vertical range of movement of the frame of the cleaning device relative to the carrier for the goods to be transported, so that the frame of the cleaning device cannot fall off the carrier for the goods to be transported when the carrier for the goods to be transported is lifted off the conveying surface of the planar motor drive system. The projections on the frame of the cleaning device thus preferably limit the vertical range of movement of the frame of the cleaning device relative to the carrier for the goods to be transported in only one direction.

With regard to the cleaning device, it should be mentioned that it can, for example, have a cleaning brush or a scraper (e.g. rubber lip), whereby the cleaning brush or the scraper rests on the conveying surface of the planar motor drive system during operation in order to clean the conveying surface in the conveying path of the carrier for the goods to be transported and keep it free of dirt. This is intended to prevent dirt particles from penetrating into the gap between the carrier for the goods to be transported and the conveying surface of the planar motor drive system, thereby causing the carrier for the goods to be transported to leave its predetermined levitation height.

The cleaning brush or scraper is preferably arranged on the underside of the frame of the cleaning device so that the weight of the frame presses on the cleaning brush or scraper. This means that the cleaning brush or scraper presses against the conveying surface with the entire weight of the frame of the cleaning device, which contributes to a good cleaning effect.

It should be mentioned here that the cleaning brush or scraper preferably runs continuously and without interruption over the entire circumference of the frame of the cleaning device in order to prevent dirt from penetrating into the gap between the carrier for the goods to be transported and the conveying surface of the planar motor drive system. This is advantageous because the cleaning effect is then independent of the direction of movement of the carrier for the goods to be transported on the conveying surface.

It should also be mentioned that the cleaning brush or the scraper can be made at least partially of polytetrafluoroethylene (PTFE), which is also known under the product name Teflon®. Alternatively, it is possible for the scraper to be designed as a rubber lip.

In addition, it should also be mentioned that the cleaning brush or the scraper is preferably mounted on the frame of the cleaning device in a replaceable manner. This is advantageous because a worn cleaning brush or a worn scraper can then be easily replaced without having to replace the entire frame.

In the preferred embodiment of the invention, the actual carrier for the goods to be transported has an upper part and a lower part, with the upper part being mechanically detachably connected to the lower part, for example by a latching connection. For example, the lower part can have latching pins on its upper side, which protrude upwards and can be latched into latching receptacles on the underside of the upper part.

It has already been mentioned above that the mechanical coupling between the carrier for the goods to be transported and the cleaning device in the carrier system for the goods to be transported according to the invention enables a vertical range of movement. This vertical range of movement of the carrier relative to the cleaning device is preferably at least 1 mm, 2 mm, 3 mm or even at least 5 mm.

It should also be mentioned that the carrier system for goods to be transported according to the invention is generally suitable for receiving and conveying goods. Preferably, however, the carrier system for goods to be transported according to the invention is designed to convey food products. For this purpose, the carrier system for goods to be transported must meet certain requirements, which relate to hygiene, for example, and are defined in EU Directive 2006/42/EC, among others. The transported food products can be, for example, stacks of slices of sausage or slices of cheese, to name just two examples.

The depositing of the goods to be transported (e.g. stacks of sausage slices or cheese slices) on the loading surface of the carrier for the goods to be transported and the removal of the goods to be transported from the loading surface is preferably carried out by so-called finger conveyors, which grip under the conveyed goods on the loading surface. For this purpose, several parallel and elongated recesses are preferably arranged in the loading surface of the carrier for the goods to be transported, into which the so-called finger conveyors can dive into when depositing or removing the goods to be transported in order to grip the goods to be transported.

It has already been mentioned above that the vertical freedom of movement between the cleaning device on the one hand and the carrier for the goods to be transported on the other offers the advantage that the maximum load capacity of the carrier for the goods to be transported is not reduced by the weight of the cleaning device. The cleaning device can therefore be designed to be heavier in order to achieve a high contact pressure with a correspondingly good cleaning effect. For example, the cleaning device can have a mass of at least 50 g, 100 g, 200 g or at least 300 g.

The carrier system for the goods to be transported according to the invention, which is suitable for use with a planar motor drive system, has been described above. However, the invention also claims protection for a planar motor drive system with at least one such carrier system for the goods to be transported.

With regard to the design and operation of the planar motor drive system, reference can be made to the state of the art, whereby such planar motor drive systems are also commercially available. For example, the German company Beckhoff Automation Gmbh & Co KG sells a corresponding planar motor drive system under the product name XPlanar®. Alternatively, it is possible to use the planar motor drive system sold by the German company Bosch Rexroth AG under the product name ctrlX FLOW6D®. It should generally be mentioned here that the planar motor drive system preferably operates electromagnetically, whereby the planar motor drive system operates contactlessly, i.e. without any contact between the goods to be transported and the conveying surface of the planar motor drive system.

Preferably, all carriers for the goods to be transported of the planar motor drive system are designed in the manner described above in accordance with the invention, i.e. all carriers for the goods to be transported have an integrated cleaning device.

Furthermore, it should be mentioned that the invention does not only claim protection for the above-described carrier system for the goods to be transported according to the invention and the likewise above-described planar motor drive system with such a carrier system for the goods to be transported. Rather, the invention also claims protection for a food processing line with such a carrier system for the goods to be transported.

Finally, the invention also claims protection for the novel use of such a carrier system for the goods to be transported or such a planar motor drive system for conveying food products in a food processing line.

### BRIEF DESCRIPTION OF THE DRAWINGS

FIG. 1 shows a perspective view of a carrier system for the goods to be transported according to the invention from above.

FIG. 2 shows a perspective view of the cleaning device of the carrier system for the goods to be transported according to FIG. 1 without the actual carrier for the goods to be transported.

FIG. 3A shows a sectional view of the carrier system for the goods to be transported according to the invention.

FIG. 3B shows an enlarged detailed view of FIG. 3A.

FIG. 4 shows a schematic representation of a planar motor drive system according to the invention with a carrier system for the goods to be transported according to the invention.

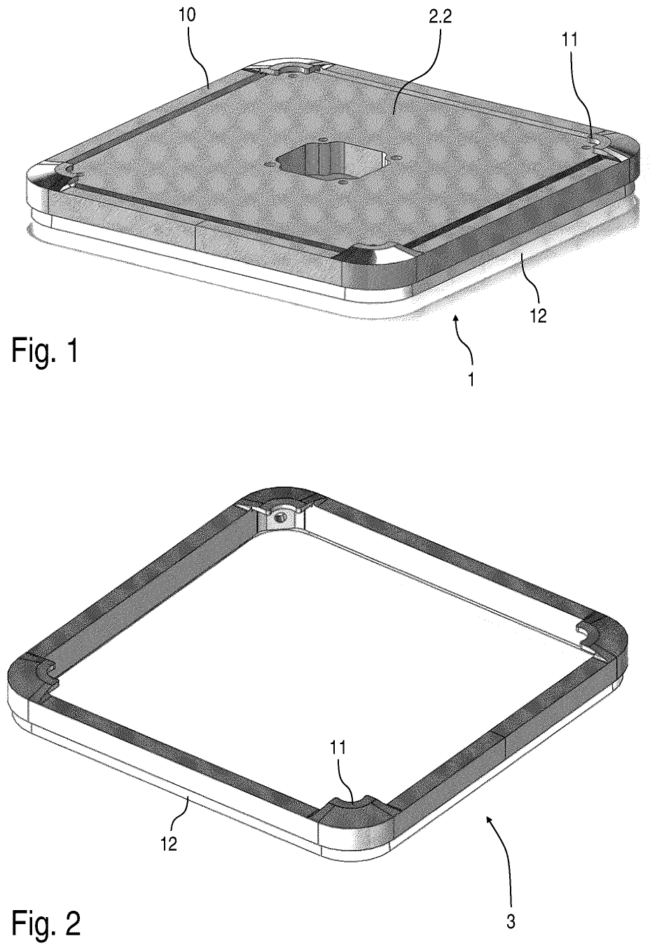

### DETAILED DESCRIPTION OF THE DRAWINGS

In the following, the carrier system 1 for the goods to be transported according to the invention shown in the drawings is described, which essentially consists of a carrier 2 for the goods to be transported and a cleaning device 3.

The carrier system 1 for the goods to be transported can be moved contactlessly along the conveying surface 5 by a planar motor drive system 4 on a conveying surface 5 of the planar motor drive system 4, whereby the carrier 2 for the goods to be transported hovers at a certain levitation height above the conveying surface 5 of the planar motor drive system 4, so that in operation there is a gap 6 between the conveying surface 5 of the planar motor drive system 4 and the carrier 2 for the goods to be transported. The planar motor drive system 4 consists of numerous rectangular modules 7, 8, 9, which are assembled without gaps to form the conveying surface 5, as is known from the prior art. For example, the planar motor drive system 4 may be the system marketed by the German company Beckhoff Automation GmbH under the product name XPlanar®.

The carrier 2 for the goods to be transported is essentially rectangular and is surrounded by a frame 10 of the cleaning device 3, which is also rectangular. The inner contour of the frame 10 is slightly oversized compared to the outer contour of the carrier 2 for the goods to be transported. This allows a vertical range of movement of the carrier 2 for the goods to be transported relative to the frame 10 of the cleaning device.

However, this range of movement is limited in the vertical direction by projections 11, which are arranged at the corners of the frame 10 of the cleaning device 3 and project inwards beyond the inner contour of the frame 10 of the cleaning device 3. If the carrier 2 for the goods to be transported is lifted from the conveying surface 5 of the planar motor drive system 4, these projections 11 prevent the frame 10 of the cleaning device 3 from dropping downwards.

On its underside, the frame 10 carries a cleaning brush 12, which runs around the entire circumference of the frame 10 of the cleaning device 3 without interruption. This enables a constant cleaning effect on the conveying surface 5 regardless of the direction of movement of the carrier system 1 for the goods to be transported.

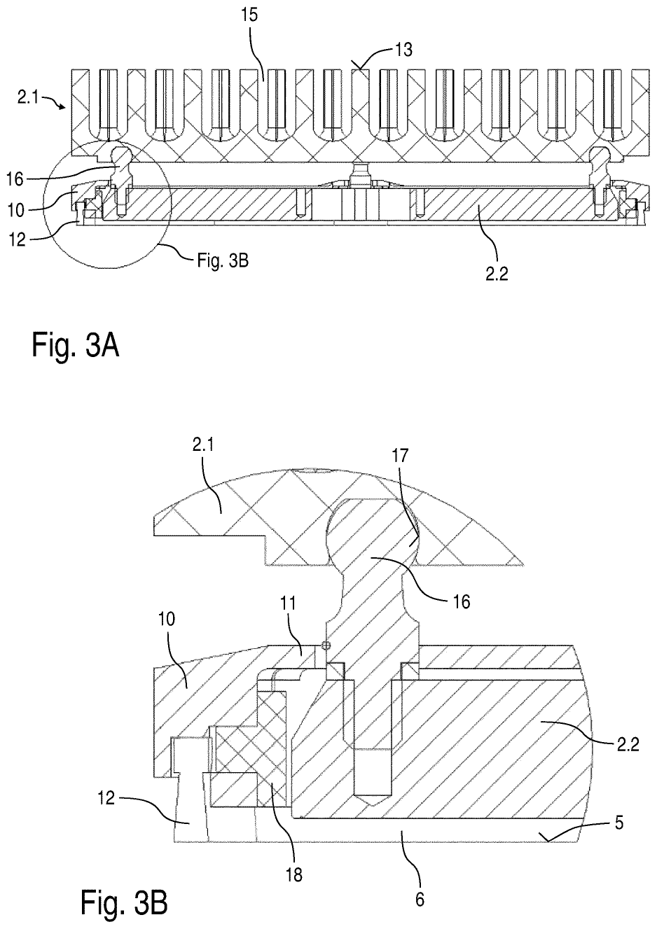

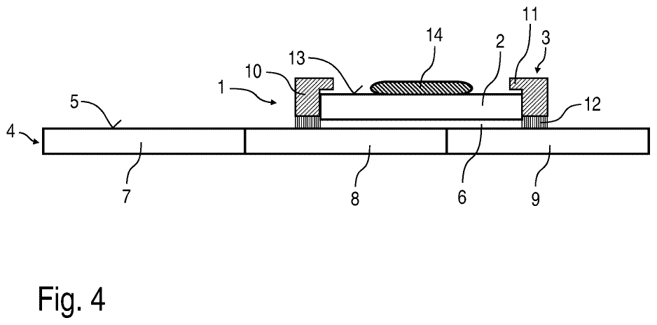

The cross-sectional view in FIG. 3A shows that the carrier 2 for the goods to be transported consists of an upper part 2.1 and a lower part 2.2. The upper part 2.1 of the carrier 2 for the goods to be transported has a loading surface 13 on its upper side for receiving conveyed goods 14 (see FIG. 4), whereby the conveyed goods 14 can be, for example, stacks of slices of sausage or slices of cheese, to name just two examples.

There are elongated parallel recesses 15 in the loading surface 13 of the carrier 2 for the goods to be transported, which make it possible for so-called finger conveyors to dive into the recesses 15 when the goods 14 are removed from the loading surface 15 or when the goods 14 are placed on the loading surface 15, thereby engaging under the goods 14.

It should also be mentioned that the upper part 2.1 of the carrier 2 for the goods to be transported is connected to the lower part 2.2 of the carrier 2 by a latching connection. This latching connection comprises latching pins 16, which are arranged in the upper side of the lower part 2.2 and project upwards. Furthermore, the latching connection comprises latching receptacles 17 on the underside of the upper part 2.1. The latching pins 16 can latch into the latching receptacles 17 and thereby establish the latching connection between the upper part 2.1 and the lower part 2.2 of the carrier 2 for the goods to be transported.

It should also be mentioned that the frame 10 and the lower part 2.2 of the carrier 2 for the goods to be transported are each made of stainless steel. Direct contact between the stainless steel frame 10 on the one hand and the stainless steel lower part 2.2 on the other should be prevented. A spacer 18 is therefore arranged between the frame 10 and the lower part 2.2 of the carrier 2 for the goods to be transported, which may be made of plastic, for example, and is detachably mounted in the frame 10.

FIG. 3B also shows that the cleaning brush 12 is also detachably mounted in the frame 10 of the cleaning device 3. If the cleaning brush 12 is worn, it can therefore be easily replaced.

The invention is not limited to the preferred embodiment described above. Rather, a large number of variants and modifications are possible which also make use of the inventive concept and therefore fall within the scope of protection. The invention therefore also claims protection for the subject matter and the features of the dependent claims independently of the claims referred to in each case and, in particular, also without the features of the main claim. The invention thus comprises various aspects of the invention which enjoy protection independently of each other.

### ADVANTAGES OF THE INVENTION

One advantage of the invention is that the maximum load capacity (payload) of the carrier for the goods to be transported on the planar motor drive system is not reduced by the weight of the cleaning device. As a result, the maximum load capacity (payload) can be increased.

A further advantage of the invention is that the cleaning device can be designed to be heavier, which leads to a higher contact pressure of the cleaning device on the conveying surface and thus to a better cleaning effect.

In addition, the circumferential arrangement of the cleaning brush or scraper prevents dirt from entering the gap between the carrier for the goods to be transported and the conveying surface of the planar motor drive system, regardless of the direction of movement.

In general, it can be said that the interference resistance of the carrier system for the goods to be transported according to the invention is significantly higher than in the state of the art.

### LIST OF REFERENCE SYMBOLS

1 Carrier system for the goods to be transported
2 Carrier for the goods to be transported
2.1 Upper part of the carrier for the goods to be transported
2.2 Lower part of the carrier for the goods to be transported
3 Cleaning device
4 Planar motor drive system
5 Conveying surface of the planar motor drive system
6 Gap between the conveying surface of the planar motor drive system and the carrier for the goods to be transported
7-9 Modules of the planar motor drive system
10 Frame of the cleaning device
11 Projections on the top of the frame of the cleaning device
12 Cleaning brush on the underside of the frame of the cleaning device
13 Loading surface of the carrier for the goods to be transported
14 Conveyed goods
15 Recesses in the loading surface of the carrier for the goods to be transported for reaching under the food product on the loading surface
16 Latching pin in the lower part of the carrier for the goods to be transported
17 Latching receptacle in the upper part of the carrier for the goods to be transported
18 Spacer between the frame of the cleaning device and the carrier for the goods to be transported

1. A carrier system for goods to be transported for movement on a substantially horizontal conveying surface of a planar motor drive system, the carrier system comprising:
a carrier including a loading surface on an upper side of the carrier, the carrier being configured to receive goods to be transported;
a cleaning device configured to clean the conveying surface of the planar motor drive system; and
a mechanical coupling provided in a horizontal direction between the carrier and the cleaning device, wherein the carrier moves the cleaning device during a horizontal movement along the conveying surface,
and wherein the mechanical coupling permits a range of movement between the carrier and the cleaning device in a vertical direction at right angles to the conveying surface or a free vertical relative movement of the carrier relative to the cleaning device.

2. The carrier system according to claim 1, wherein the cleaning device rests on the conveying surface of the planar motor drive system during operation and is supported in the vertical direction solely by the conveying surface of the planar motor drive system, so that the cleaning device does not form a load-bearing load in the vertical direction for the carrier.

3. The carrier system according to claim 1, wherein
that the cleaning device forms a frame which surrounds the carrier, and/or
that the frame has an inner contour and the carrier has an outer contour, the inner contour of the frame being shaped to complement the outer contour of the carrier.

4. The carrier system according to claim 3, wherein
the inner contour of the frame is essentially rectangular,
the outer contour of the carrier transported is essentially rectangular, and
the inner contour of the frame has an oversize relative to the outer contour of the carrier, so that there is a gap between the outer contour of the carrier and the inner contour of the frame, wherein the gap permits the free vertical relative movement of the carrier relative to the cleaning device.

5. The carrier system according to claim 3, wherein
the frame is at least partially made of metal,
the carrier is at least partially made of metal, and
further comprising a spacer made of plastic is arranged between the frame and the carrier, the spacer preventing direct contact between the frame and the carrier.

6. The carrier system according to claim 3, wherein the frame has projections on an upper side which project inwards beyond the inner contour of the frame and limit a vertical range of movement of the frame relative to the carrier, so that the frame cannot fall away from the carrier when the carrier is lifted from the conveying surface of the planar motor drive system.

7. The carrier system according claim 4, wherein
the cleaning device has a cleaning brush or a scraper which rests on the conveying surface of the planar motor drive system during operation in order to clean the conveying surface of a planar motor drive system, and/or
the cleaning brush or the scraper is arranged on an underside of the frame, and/or
the cleaning brush or the scraper runs continuously and without interruption over an entire circumference of the frame in order to prevent dirt from penetrating into the gap between the carrier and the conveying surface of the planar motor drive system, and/or
the cleaning brush or the scraper is comprised at least partially of polytetrafluoroethylene, and/or
the scraper has at least one rubber lip, and/or
the cleaning brush or the scraper is replaceable.

8. The carrier system according to claim 1, wherein
the carrier has an upper part and a lower part, and/or
the upper part is mechanically detachably connected to the lower part by a latching connection, and/or
the latching connection has latching pins in the lower part and latching receptacles in the upper part, wherein the latching pins can be latched into the latching receptacles.

9. The carrier system according to claim 1,
the mechanical coupling between the carrier and the cleaning device allows a vertical range of movement of the carrier relative to the cleaning device of at least 1 mm, 2 mm, 3 mm or 5 mm, and/or
the carrier system is designed for use with food products, and/or
the carrier has a plurality of parallel and elongated recesses in the loading surface for engaging under the goods when the goods are deposited on the carrier or when the goods are removed from the carrier, and/or
the cleaning device has a mass of at least 50 g, 100 g, 200 g or at least 300 g in order to prevent the cleaning device from lifting from the conveying surface of the planar motor drive system.

10. The carrier system according to claim 1, in combination with a planar motor drive system, wherein the carrier system is movably arranged on the conveying surface of the planar motor drive system.

11. The carrier system and planar motor drive system according to claim 10, wherein
the planar motor drive system operates electromagnetically, and/or
the planar motor drive system operates contactlessly without any contact between the carrier and the conveying surface of the planar motor drive system.

12. The carrier system and planar motor drive system according to claim 10, wherein
the carrier levitates above the conveying surface of the planar motor drive system at a certain levitation height during operation, and
a vertical range of movement of the carrier relative to the cleaning device is greater than the levitation height of the carrier.

13. A food processing line comprising a carrier system according claim 1.

14. (canceled)

15. A food processing line comprising a carrier system and planar motor drive system according to claim 10.

16. The carrier system according to claim 4, wherein
the frame is at least partially made of metal,
the carrier is at least partially made of metal, and
further comprising a spacer made of plastic is arranged between the frame and the carrier, the spacer preventing direct contact between the frame and the carrier.

17. The carrier system according to claim 4, wherein the frame has projections on an upper side which project inwards beyond the inner contour of the frame and limit a vertical range of movement of the frame relative to the carrier, so the frame cannot fall away from the carrier when the carrier is lifted from the conveying surface of the planar motor drive system.

18. The carrier system according to claim 1, wherein the cleaning device has a cleaning brush or a scraper which rests on the conveying surface of the planar motor drive system during operation in order to clean the conveying surface of a planar motor drive system, and the scraper having at least one rubber lip.
